(19) United States
(12) Patent Application Publication
(10) Pub. No.: US 2011/0052113 A1
(43) Pub. Date: Mar. 3, 2011

(54) BALANCER FOR A ROTATING OBJECT

(76) Inventors: Ryan J. TANNER, Lethbridge (CA); Tyler W. TANNER, Lethbridge (CA); Mitchell KRATCHMER, Lethbridge (CA)

(21) Appl. No.: 12/868,222

(22) Filed: Aug. 25, 2010

(30) Foreign Application Priority Data
Aug. 25, 2009 (CA) 2,677,902

(51) Int. Cl. F16C 33/58; B23P 11/00

(52) U.S. Cl. 384/513; 29/428

(57) ABSTRACT

A balancer for a rotating object includes a rigid body having a first portion and a second portion. The first portion defines a lower section of a circular raceway and the second portion defines an upper section of the circular raceway. A balancing medium is positioned within the circular raceway. A connector connects the first portion and the second portion to form the circular raceway.

### FIELD

A balancer for balancing and stabilizing a rotating object

### BACKGROUND

U.S. Pat. No. 3,733,923 (Goodrich et al.) entitled “Economical Automatic Balancer for Rotating Masses” and U.S. Pat. No. 5,142,936 (McGale) entitled “Apparatus for dynamical balancing of rotating objects and method for making same” describe balancers that are made from a bent metallic tube, and filled with spherical counterweights and damping fluid. Other known balancing devices use mercury as the counter weight.

### SUMMARY

There is provided a balancer for a rotating object comprising a rigid body having a first portion and a second portion. The first portion defines a lower section of a circular raceway and the second portion defines an upper section of the circular raceway. A balancing medium is positioned within the circular raceway. A connector connects the first portion and the second portion to form the circular raceway.

According to another aspect, there is provided a method of forming a balancer for a rotating object, comprising the steps of

forming a first portion of a rigid body to form a lower section of a circular raceway, the lower section having a volume sufficient to contain a balancing medium, the first portion having a first threaded surface;

forming a second portion of a rigid body to form an upper section of the circular raceway, the upper section having a second threaded surface for engaging the first threaded surface;

filling the lower section with a balancing medium; and

attaching the first portion and the second portion by threading the threaded recessed cavity onto the threaded upstanding flange to form the circular raceway.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of a dynamically balancing apparatus.

FIG. 2 is an exploded side elevation view in section of a dynamically balancing apparatus.

FIG. 3 is a top plan view of the first portion of the dynamically balancing apparatus.

FIG. 4 is a top plan view of the second portion of the dynamically balancing apparatus.

FIG. 5 is an exploded side elevation view in section of an alternative dynamically balancing apparatus.

### DETAILED DESCRIPTION

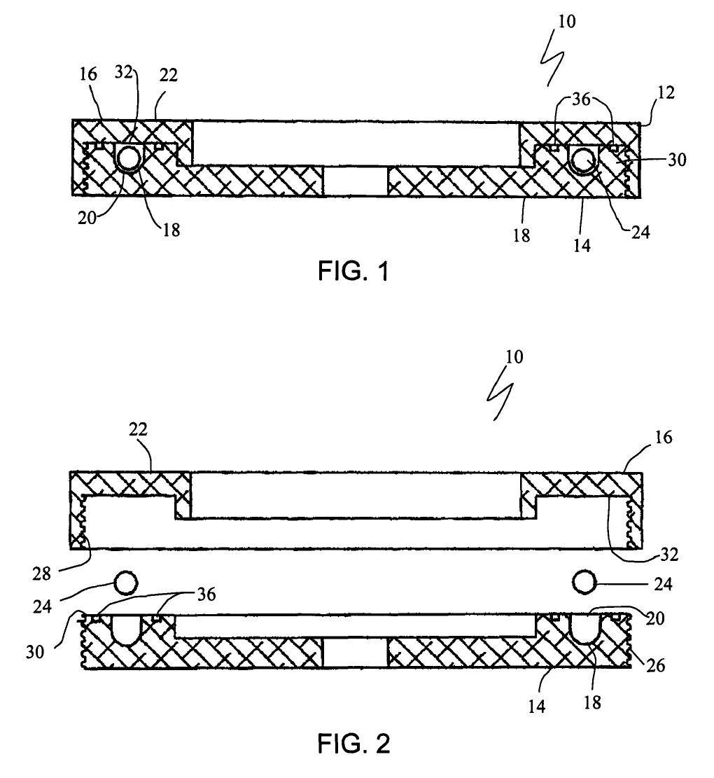

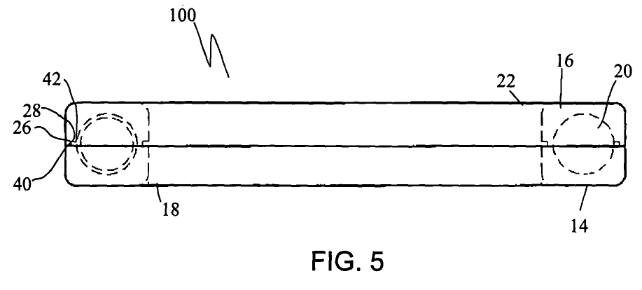

A balancer for a rotating object, generally identified by reference numeral 10 will now be described with reference to FIG. 1 through 4. An alternative embodiment will then be described with reference to FIG. 5.

### Structure and Relationship of Parts:

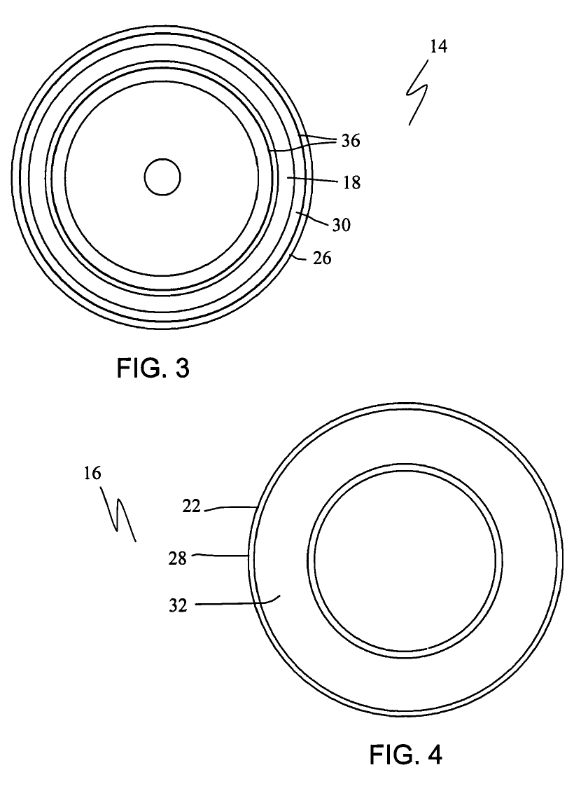

Referring to FIG. 1, balancer 10 is made from a rigid body 12 having a first portion 14 and a second portion 16. Referring to FIGS. 3 and 4, first portion 14 and second portion 16 of rigid body 12 are preferably annular in shape. The cross-section of rigid body 12 need not be circular, and may be square or rectangular, as shown in FIG. 1. The shape of rigid body 12 must be able to accommodate a circular raceway 20, and to allow for a balanced load when rotating. Referring to FIG. 2, first portion 14 defines a lower section 18 of circular raceway 20 and second portion 16 defines an upper section 22 of circular raceway 20. It will be understood that “upper” and “lower” refer to the orientation during a preferred mode of assembly. Once assembled, balancer 10 may take any orientation, depending on the intended purpose and the object to be balanced. The cross-section of circular raceway 20 may be circular, as shown in FIG. 5 or non-circular, as shown in FIG. 1. As shown in FIG. 1, upper section 22 is a cover for lower section 18, which has a rounded bottom surface, and flat sides that rise to the approximate height of the balancing medium 24 that will be placed in circular raceway 20, as will be described below. In the embodiment depicted in FIG. 2, first portion 14 has an annular upstanding section 30 with lower section 18 of circular raceway 20 being recessed into upstanding section 30 such that, when assembled, circular raceway 20 is approximately in the center of rigid body 12. Upstanding section 30 engages a recess 32 in second portion 16, which acts as the cover for lower section 18. Upstanding section 30 has seals 36 that are pressed against recess 32 to seal circular raceway 20 when assembled.

As depicted, the volume of circular raceway 20 is contained entirely in lower section 18, with upper section 22 providing a cover to enclose circular raceway 20. However, it will be understood that second portion 16 may be formed such that upper section 22 also contains some of the volume of circular raceway 20. An example of this can be found in FIG. 5, which will be described in more detail below. For ease of assembly, the volume of lower section 18 is sufficiently large to contain the entire balancing medium 24, which in most situations is between 40% and 80%, and preferably between 65% and 75% of the volume of circular raceway 20. Balancing medium 24 may be any convenient medium that is able to move in circular raceway 20. In one example, balancing medium 24 is made up of spheres in a liquid that acts as a fluid dampener for the spheres, such as liquid silicone. In another example, the balancing medium is a fluid, such as mercury or other heavy fluids.

First and second portions 14 and 16 are connected by a connector to form circular raceway 20. In the embodiment depicted in FIG. 2, this is done by providing a threaded connection. There is a first threaded surface 26 on first portion 14 that mates with a second threaded surface 28 on second portion 16.

### Method of Manufacture:

A method of manufacturing a preferred embodiment of balancer 10 will now be described. Referring to FIG. 3, first portion 14 of rigid body 12 is formed with lower section 18 of circular raceway 20. Preferably, lower section 18 is formed in annular upstanding section 30, such that circular raceway 20 is centered when balancer 10 is assembled. Lower section 18 has first threaded surface 26 and preferably has a volume sufficient to contain the balancing medium. Referring to FIG. 4, second portion 16 is formed with upper section 22 of circular raceway 20. Upper section 22 has second threaded surface 28 in recess 32 for engaging first threaded surface 26 and is designed to cover lower section 18 to enclose circular raceway 20. First and second portions 14 and 16 may be formed by machining or molding. The material is preferably aluminium, however adequate results may also be obtained using other materials that are sufficiently rigid for the intended application. Referring to FIG. 2, lower section 18 is then filled with balancing medium 24, and first portion 14 and second portion 16 are then attached by engaging upstanding section 30 and recess 32 and threading first and second threaded surfaces 26 and 28 together to enclose circular raceway 20. Once assembled, first portion 14 and second portion 16 may be welded or otherwise secured to prevent separation.

### Variations:

Referring to FIG. 5, an alternative balancer 100 is shown. As with balancer 10, balancer 100 has first and second portions 14 and 16 that combine to form circular raceway 20. As shown, circular raceway 20 has a round cross-section. In addition, circular raceway 20 has the volume divided between lower section 18 and upper section 22. First threaded surface 26 is located on one of the upstanding flanges 40, which also act to increase the volume of lower section 18. Second threaded surface 28 is located in one of the recesses 42 that correspond to upstanding flanges 40. Both flanges 40 and recesses 42 are circular.

As depicted, lower section 18 may have a volume that is less than the volume of the balancing medium. However, when spheres are used, the spheres will extend above upstanding flange 40, such that the effective volume contained is greater that what would otherwise be the case.

### Advantages:

Balancer 10 described above is designed to be used for balancers having raceways that are less than 5 inches in diameter, and preferably around 4 inches. For diameters that small, traditional methods of bending tubing are not practical, as the tight radius of curvature may result in kinks or a narrowed cross-section. By using the above-described apparatus and method, smaller balancers can be made, which can then be used on, for example, the flywheel of an ATV, such as a snowmobile.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A balancer for a rotating object comprising:
a rigid body having a first portion and a second portion, the first portion defining a lower section of a circular raceway and the second portion defining an upper section of the circular raceway;
a balancing medium positioned within the circular raceway; and
a connector for connecting the first portion and the second portion to form the circular raceway.

2. The balancer of claim 1, wherein the balancing medium fills between 40% and 80% of the volume of the circular raceway, the lower section having a sufficient volume to support the entire balancing medium.

3. The balancer of claim 1, wherein the upper section is a cover for the lower section.

4. The balancer of claim 3, wherein the first portion comprises an annular upstanding section, the lower section of the circular raceway being recessed into the upstanding section, the upstanding section engaging a recess in the first portion such that the upper section acts as the cover for the lower section.

5. The balancer of claim 1, wherein the connector comprises a first threaded surface on the first portion and a second threaded surface on the second portion.

6. The balancer of claim 2, wherein at least a portion of the balancing medium comprises spheres that extend above the lower section of the circular raceway.

7. The balancer of claim 6, wherein the first portion comprises an upstanding flange on each of an inner rim and an outer rim of the lower section.

8. The balancer of claim 1, wherein the connector comprises an upstanding flange on one of the first portion and the second portion and a cavity on the other of the first portion and the second portion corresponding to the upstanding flange, the upstanding flange and the cavity being circular and being threaded, such that the first portion and the second portion are connected by threading the upstanding flange into the cavity.

9. The balancer of claim 1, wherein the circular raceway has a circular cross-section.

10. The balancer of claim 1, wherein the circular raceway has non-circular cross-section.

11. The balancer of claim 1, wherein the balancing medium comprises a liquid.

12. The balancer of claim 11, wherein the balancing medium further comprises spheres.

13. The balancer of claim 11, wherein the circular raceway has a diameter of 5 inches or less.

14. A method of forming a balancer for a rotating object, comprising the steps of:
forming a first portion of a rigid body to form a lower section of a circular raceway, the lower section having a volume sufficient to contain a balancing medium, the first portion having a first threaded surface;
forming a second portion of a rigid body to form an upper section of the circular raceway, the second portion having a second threaded surface for engaging the first threaded surface;
filling the lower section with a balancing medium; and
attaching the first portion and the second portion by threading the first threaded surface together with the second threaded surface.

15. The method of claim 14, wherein the first and second portions are formed by machining or molding.
